(19) United States
(12) Patent Application Publication
(10) Pub. No.: US 2024/0260517 A1
(43) Pub. Date: Aug. 8, 2024

(54) A PROTECTIVE COVERING FOR MITIGATING SMOKE TAINT

(71) Applicant: Stockford Ltd, Newbury Berkshire (GB)

(72) Inventors: Peter MICHAEL, Newbury Berkshire (GB); Kerry WILKINSON, Newbury Berkshire (GB); Robert FIORE, Newbury Berkshire (GB)

(21) Appl. No.: 18/290,573

(22) PCT Filed: May 10, 2022
(86) PCT No.: PCT/IB2022/054310

§ 371 Date: Nov. 14, 2023

(30) Foreign Application Priority Data
May 21, 2021 (GB) 2107282.2

(51) Int. Cl. A01G 13/02

(52) U.S. Cl. CPC A01G 13/0237

(57) ABSTRACT

The present invention relates to a protective covering for grapevines to mitigate smoke taint by filtering particles that may affect the grapes. The protective covering: comprises a microporous activated carbon material that is capable of being arranged by a user to cover at least a portion of the grapevine; and an attachment means for securing the activated carbon material to, or about, at least the portion of the grapevine.

### FIELD OF THE INVENTION

The present invention relates to a protective covering for grapevines to mitigate smoke taint by filtering particles that may affect the grapes.

### BACKGROUND

Fruit growing is often located where hot climates are required to ripen fruit, meaning that dry conditions are common and such regions may be susceptible to wildfires that can rapidly spread over great distances. The resulting smoke from bushfires can taint fruit such as grapes and impact on the harvest.

In 2020 the West Coast of California burned from Mexico to the Canadian border for weeks which led to damage to the fruit (grapes) growing in vineyards some distance from the fires due to smoke exposure.

Although it is known that smoke taints fruit, it is not clear what is the mechanism by which smoke volatiles are taken up by fruit. It may be adsorption and the fruit may be susceptible at any stage of growth.

During the growing season, grapes are susceptible to taint from smoke, due to adsorption of volatile smoke compounds that can impart unpleasant sensory qualities (e.g. acrid smoky aromas and flavours, and a drying, ashy aftertaste). The extent to which grapes can be tainted depends on smoke density, the duration of smoke exposure, and at what stage of berry growth and development smoke exposure occurs (smoke taint can occur any time there are grapes on the vine, but fruit is thought to be more susceptible during ripening). Millions of tonnes of grapes and gallons of wine have been downgraded or discarded due to grapevine smoke exposure.

The wine industry has adopted several techniques that can remove some of the compounds responsible for smoke taint from wine. These may involve the use of adsorbent materials such as activated carbon, to bind smoke compounds removing them before bottling. Reverse osmosis and spinning cone distillation techniques can also be employed to remove smoke taint compounds. However, the methods used for removing smoke taint can also remove the desirable constituents that give wine its unique character.

Attempts have been made to apply protective sprays or coverings to fruit in the vineyard to mitigate their exposure to smoke, but the efficacy of such materials depends on their coverage, and in some cases, sprays have exacerbated the level of taint, while coverings have caused condensation which can result in mildew spoiling the fruit.

The present invention provides a protective covering for fruit that prevents smoke derived volatile phenols affecting the fruit.

### PRIOR ART

Chinese patent application CN 106750766A (CHONGQUING) discloses an agricultural black polyethylene mulching film.

Chinese patent application CN 106349538A (WANG) discloses a mulching film that decomposes quickly. The mulching film is prepared by adding a microwave absorption material in a polyvinyl plastic film, a polypropylene plastic film, a biodegradable film or a film capable of being degraded by photocatalysis.

Korean patent application KR 20120126620A (CHANG) discloses an agricultural reflective film with improved tear durability, and a manufacturing method thereof.

United States patent application US 20080115411 (RAMSEY) discloses a weed control system with an opaque portion to block passage of light and growth promoting portion.

Korean patent application KR 20110012374A (CHANG) discloses an agricultural needle-punching non-woven fabric for continuously venting. A functional component is provided to supply the agricultural needle-punching non-woven fabric and to improve the efficiency of the functional fibre.

Chinese patent application CN 112323255A (ZHEJIANG) discloses a preparation method of an oil-smoke-resistant high-efficiency filtering melt-blown fabric.

None of the prior art devices addressed the specific problem of smoke damage and taint, caused by smoke contacting or wafting over vines.

### SUMMARY OF THE INVENTION

According to a first aspect of the present invention there is provided a protective covering for at least a portion of a grapevine during berry development and growth for mitigating smoke taint: comprising a microporous activated carbon material that is capable of being arranged by a user to cover at least a portion of the grapevine; and an attachment means for securing the microporous activated carbon material to, or about, at least the portion of the grapevine.

In this way part of a grapevine, such as the grapes, canopy, or whole vine, is covered by a microporous carbon material that filters particles from the air and therefore protects the grapevine from smoke, for example from wildfires, or other smoke or exhaust pollution such as from machinery or vehicles. In particular the protective cover is intended to prevent, or at least significantly limit, uptake of smoke-derived volatile compounds (including volatile phenols) by grapes.

It is appreciated that the protective covering may be used for any plant where smoke taint may damage the harvest. Although the application refers to grapevines and grapes this is an example, and the protective covering is suitable for use on other plants.

As the protective covering filters undesirable particles from the air, these undesirable particles do not contact the surface of the grapevine (including fruit) and are not able to be adsorbed by the grapevine. Therefore, the grapes when harvested, are not tainted by the smoke as the volatile smoke compounds have either not been taken up or are only adsorbed at concentrations that are so low that it is not detrimental to the production of wine. This is important as it prevents loss of a harvest where smoke taint affects the grapes and makes them unsuitable for wine production as flavours are altered.

Once a grapevine enters veraison there is no longer a requirement for light to ripen the grapes, instead temperature is the main factor. Therefore the covering of the grapes once at the veraison stage may not be problematic for ripening.

In some embodiments the microporous activated carbon material is provided as an elongated sheet on a roll with attachment means provided at locations around an outer edge of the elongated sheet. In this way the microporous activated carbon material can be arranged about a grapevine or series of grapevines, and can be secured in place by the attachment means that permit attachment to the grapevine, other structures such as supports, or to itself.

The attachment means may comprise eyelets for receiving a tie or clip. For example, a series of eyelets may be provided along the lengths of the material, through which connecting means such as ties or clips can be received.

Or the attachment means may comprise corresponding interlocking parts, for example one sheet of microporous activated carbon material may have female parts and a second sheet, or connector, may have male parts so that a sheet to two or more sheets of microporous activated carbon material can be arranged and connected one to the other by way of the attachment means.

In yet a further embodiment the attachment means may comprise patches and/or strips of hook and loop means. For example at least one strip of hooks may be provided on a first sheet and at least one strip of loops may be provided on a second sheet so that both sheets can be connected about a grape vine or other plant.

In some embodiments, attachment means may be provided at locations other than an edge of the sheet, for example at mid-points across the sheet. This may provide additional securing locations.

It is appreciated that an elongated sheet or sheets may be arranged to enclose an entire grapevine, or optionally just the fruiting zone.

In another embodiment the microporous activated carbon material is provided as a bag for receiving a bunch of grapes on the grapevine. The bag has an opening through which the bunch of grapes is received, and an attachment means for closing the bag and securing the bag to the grapevine. In this way the grapes are enclosed by the filtering material.

The attachment means of the bag may comprise a drawstring that acts to close the bag. The ties of the drawstring may also be used to anchor the bag to the grapevine.

Alternative means for closing the bag may be provided, for example the bag may have a zipper, clip, press studs, ties, hook and loop means or ferromagnetic connectors.

In this way the grapes are enclosed by the filtering material and thereby protected from smoke.

Preferably the microporous activated carbon material is treated so that after low-temperature carbonisation and high-temperature activation, the non-carbon components are burned away, and the remaining carbon components of the microporous activated carbon material are left. In this way the microporous activated carbon material has very good adsorption capability.

Preferably the microporous activated carbon material is produced by heating a woven fabric that includes long carbon chain organic threads. The woven fabric is heated in a furnace that has a reducing atmosphere. After exposing the activated carbon material to the relevant temperature, for the desired time, a processed material with activated carbon is produced.

Preferably the microporous activated carbon material is woven with foundation threads, then carbonised and subsequently the remainder of the foundation threads dissolved away.

Ideally the microporous activated carbon material has high adsorption capacity and fast adsorption velocity, the activated carbon can be easily regenerated, the microporous activated carbon material is heat-resistant, acid resistant and alkaline-resistant, and has a low ash content.

In some embodiments the tear strength of the microporous activated carbon material may be enhanced by leaving the original foundation threads in place to support what may be a delicate carbon lattice.

In a preferred embodiment the microporous activated carbon material comprises a viscose material or a cotton material which is breathable.

In some embodiments the microporous activated carbon material includes impregnated cloth. A preferred example of a microporous activate carbon cloth is HNCFC-800. HNCFC-800 has a preferred thickness of 0.3-0.35 mm and a preferred standard weight of 70-80 g/m².

In some embodiments the microporous activated carbon material is a felt material. Felt is typically thicker than cloth, but due to the arrangement of the fibres felt tends to tear more easily than cloth which typically has more uniform fibres.

An option to enhance the strength of a microporous activated carbon felt is to use a thicker felt. A preferred example of a microporous activated carbon felt is HNCFF-800.

It is appreciated that different grades of microporous activated carbon material may be used, for example to increase the surface area BET (m²/g) or to increase the adsorption capacity.

Typically the microporous activated carbon material is black in colour by nature of the carbon.

In some embodiments the microporous activated carbon material includes one or more heat-resistant materials. In this way it is easily possible to extend the life of the activated carbon in the microporous activated carbon material by heating the material and thereby the activated carbon. In this way the microporous activated carbon material can be re-used.

Typically the material will be treated using a gas adsorption equipment system. For example, after 120° C. of hot steam is applied, the microporous activated carbon material can experience desorption and then be used again.

In some embodiments the protective cover may be formed from two or more layers of material. This may be two or more layers of microporous activated carbon material or one layer of microporous activated carbon material and a second layer, or a plurality of layers of a different porous material.

For example, it may be desirable for the outer layer of the protective cover to not be black in order to reduce heat absorbed from the sun. Therefore an outer layer of material in a different colour may be provided.

Alternatively a second layer (or optionally a third or more layer) of material may be a mesh that improves the strength of the protective cover. Advantageously this will help prevent tearing of the microporous activated carbon material and ensure that the grapevine is protected from smoke particles.

In some embodiments two or more layers of activated carbon material are connected together by an adhesive so that the layers are not separable.

In another embodiment the layers are connected by a connecting means. For example the connecting means may be stitching, an array of connectors such as rivets, or a combination of any of the beforementioned connection means.

In another embodiment, a reinforcing material may be integrated, or formed with or connected to, the protective cover as part of the manufacture process. The reinforcing material may be introduced before the process of activation of the carbon, or after the carbon activation process has occurred.

When introducing a reinforcing material prior to the carbon activation process, the reinforcing material must be capable of withstanding the process of activating the carbon which includes heating and reduction so that the properties of neither the fabric nor the reinforcing material are compromised.

In a preferred embodiment the reinforcing material may comprise threads, such as metal threads, that are woven into the fabric. In a preferred example, a strong thread may be integrated evenly across the fabric to provide mechanical reinforcement. For example, every tenth thread may be formed from metal, or a metal alloy, so that added strength is incorporated into the fabric prior to processing to introduce the activated carbon. It is appreciated that the weave of the fabric may include the metal thread in either the warp or the weft, or both, to provide a matrix of support.

In an alternative embodiment reinforcing material may be introduced after the activated carbon introduction process. In this way reinforcing material or structure may be introduced to the activated carbon material after the process of activating the carbon. For example, reinforcement may be provided by sewing a reinforcing thread onto the activated carbon fabric.

The reinforcing thread may be sewn in a pattern that improves strength of the fabric. As this method of reinforcing the activated carbon material is a process applied after the process of activating the carbon, the reinforcing material is not required to withstand high temperatures that are used to produce activated carbon. This technique therefore allows a wider range of suitable materials to be used to reinforce the fabric. Furthermore this method may enable a standard strong sewing thread of a type common in the fabric industry to be used for reinforcing the material.

The microporous activated carbon material has preferred pore size distribution in order to filter undesirable particles of smoke to prevent smoke taint and to allow circulation of desirable or non-problematic particles.

Ideally the specific surface area Brunauer Emmett Teller (BET) of the protective cover is at least 800+/−50 m²/g.

Typically, the higher the surface area of the microporous activated carbon material the higher the adsorption capacity of the material.

The texture and weave of the microporous activated carbon material are important. For example, unstructured material such as felt tears more easily and may therefore not be suitable for repeated use.

In some embodiments the protective material may include a viewing window to enable the grapes (or other fruit) to be viewed without requirement for the cover to be removed. For example, the elongated sheet or bag may have one or more transparent plastic window through which an observer can view the grapes.

In some embodiments the protective material may include a displaceable access flap or an elongate access slot which enables access to part of the plant to be inspected or to be picked, for example so as to view or sample the fruit.

The flap or elongate slot may have a securing means to keep the flap or elongate slot closed unless a user actively opens the flap or pushes their hand through an elongate slot. In this way the part of the plant that is covered remains protected from smoke taint. For example the flap or elongate slot may be closed by a toggle, ferromagnetic means, a press stud or hook and loop means or other similar means.

In another embodiment the protective covering may include pockets to permit storage of items or information. For example the pocket may be used to store a card that includes and optionally displays information about the grapevine, or the pocket may hold tools for tending or monitoring the fruit or environmental conditions such as temperature or humidity, or provide a space to store a treatment for the grapevine, such as a bug deterrent.

The one or more pocket may be provided on an outer face of the material, or on an inner face of the material. It is appreciated that the pocket may not be made from the same material as the protective cover.

In some embodiments the protective cover may include one or more sensor to monitor surrounding conditions that may include but are not limited to: temperature, humidity, pollution, light levels, proximity. In this way conditions can be recorded.

In yet a further embodiment the sensor(s) may be operatively connected to a transmitter to enable data to be transmitted to a receiver on a remote device, such as a smartphone, to enable conditions to be monitored remotely.

Furthermore monitoring proximity may enable a user to ensure regular checking of the plants has been completed and to be alerted of unauthorised access to a growing area.

In some embodiments the protective cover may include one or more lights, for example a light emitting diode (LED) connected to a power supply such as a battery.

Preferred embodiments of the invention will now be described, by way of example and with reference to the Figures in which:

### BRIEF DESCRIPTION OF FIGURES

FIG. 1A shows table 1 of test data;

FIG. 1B shows table 2 of test data;

FIG. 2A shows smoke taint mitigation trials;

FIG. 2B shows the results of the trial shown in FIG. 2A;

FIG. 3A shows a second smoke taint mitigation trial; and

FIG. 3B shows the results of the trial shown in FIG. 3A.

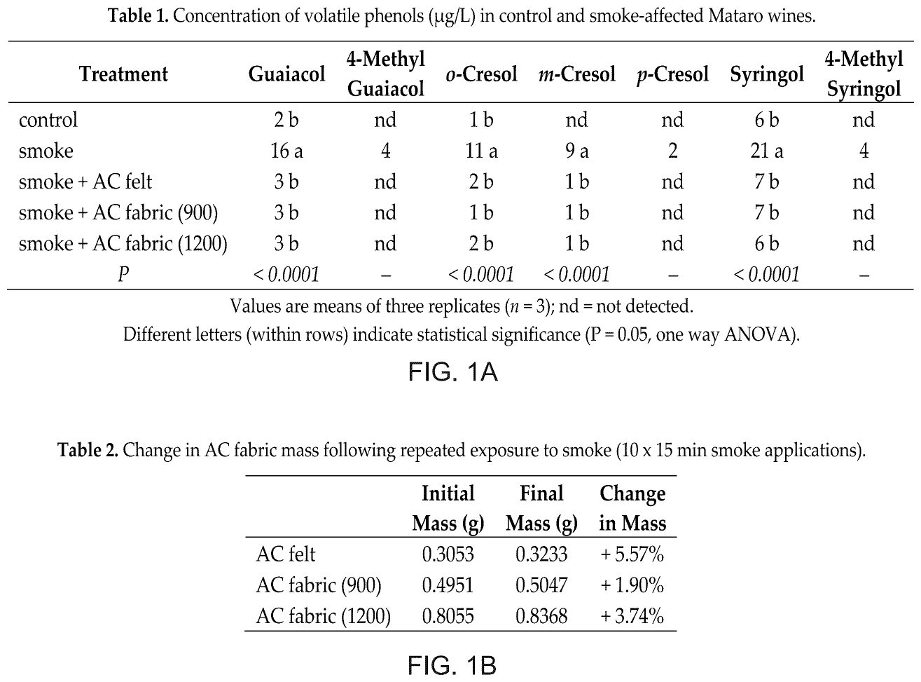

### DETAILED DESCRIPTION OF FIGURES

Table 1 shows concentration of volatile phenols measured in μg/L in control and smoke-affected Mataro wines.

Column 1 lists five different treatments applied to grapes.
a control (not exposed to smoke),
grapes exposed to smoke
grapes are covered by an activated carbon felt material,
grapes are covered by an activated carbon cloth (900), and
grapes are covered by an activated carbon cloth (1200).

Columns 2 to 8 are readings of seven different volatile phenol levels: Guaiacol, 4-Methylguaiacol, o-Cresol, m-Cresol, p-Cresol, Syringol and 4-Methylsyringol.

The results reveal no statistical differences amongst the volatile phenol levels in the control Mataro wine and the wines made with Mataro grapes that were in AC fabric bags during smoke exposure. This indicates that the use of bags formed from activate carbon material (cloth or felt), that cover the grapes during smoke exposure, prevents significant smoke taint.

The three fabrics, activated carbon felt material, activated carbon fabric (900) and activated carbon fabric (1200) have provided very similar levels of protection.

Table 2 shows the changes detected in the mass of each of the three types of activated carbon materials following exposure to smoke ten times for 15 minutes for each exposure. The results for each type of material reveal an increase in mass reflecting the particles captured by the material.

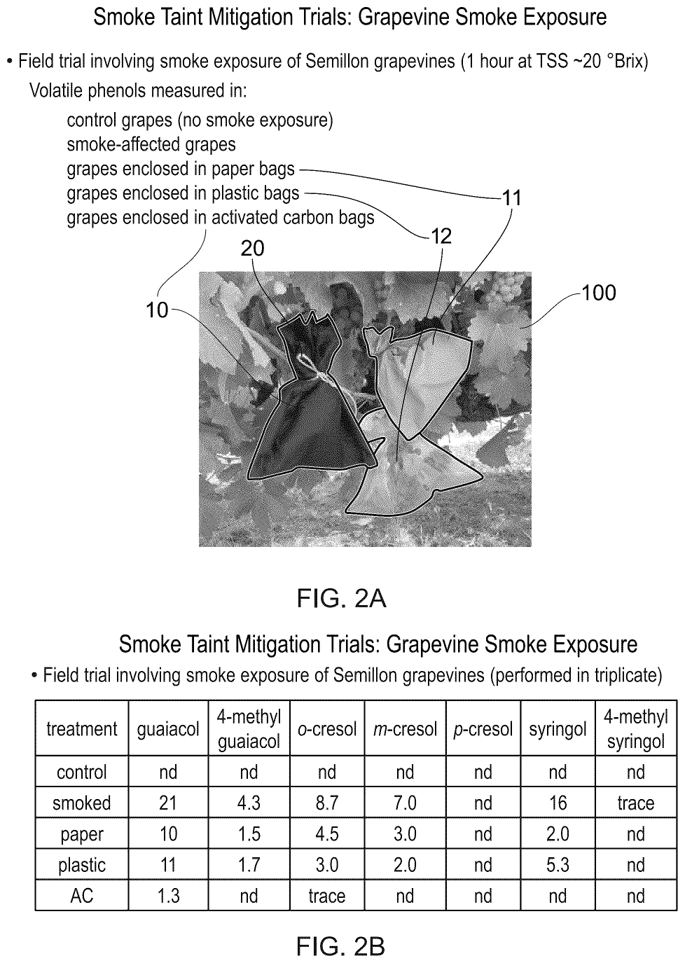

FIG. 2A shows smoke taint mitigation trials using different materials to include paper bags 11, plastic bags 12 and bags formed from a fabric with activated carbon 10.

The bags 10, 11, 12 are arranged to fully enclose a bunch of grapes. The bags 10, 11, 12 have a tie 20 that closes the opening of the bags and also acts to attach the bag to the grapevine 100.

FIG. 2B shows the results of the trial shown in FIG. 2A. The results reveal that covering the grapes in paper or plastic does reduce the levels of smoke derived volatile phenols detected, although not to the same extent as when using the bag formed from activated carbon fabric.

The use of paper or plastic bags are also more likely to lead to condensation within the bag and therefore a risk of mildew which can damage the fruit.

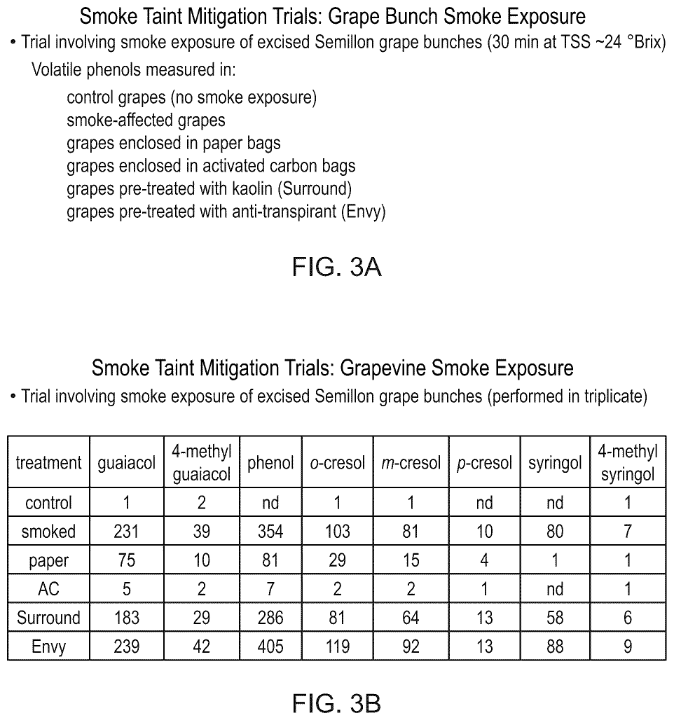

FIG. 3A shows a second smoke taint mitigation trial using bags formed from an activated carbon fabric, paper bags, grapes pre-treated with kaolin and grapes pre-treated with antitranspirant.

FIG. 3B shows the results of the trial shown in FIG. 3A reveal that only the use of bags formed from an activated carbon fabric make a significant difference to the concentration of phenols detected after smoke exposure.

The paper bag reduces the concentration of phenols detected, but not to the same degree.

The pre-treatments of kaolin to the grapes did slightly reduce the level of phenols detected on the grapes but not to the same degrees as the activated carbon bags.

For grapes treated with antitranspirant some concentrations of phenols detected are actually higher than those detected on smoked grapes with no covering or pre-treatment. This may indicate that the pre-treatment of antitranspirant increases adsorption of smoke-derived volatile phenols.

The invention has been described by way of examples only and it will be appreciated that variation may be made to the above-mentioned embodiments without departing from the scope of protection, as defined by the claims.

1-28. (canceled)

29. A protective covering for at least a portion of a grapevine during berry development and growth for mitigating smoke taint: comprising a microporous activated carbon material that is capable of being arranged by a user to cover at least a portion of the grapevine; and an attachment means for securing the activated carbon material to, or about, at least the portion of the grapevine.

30. A protective covering according to claim 29 wherein the microporous activated carbon material is provided as an elongated sheet on a roll with attachment means provided at locations around at least an outer edge of the elongated sheet.

31. A protective covering according to claim 29 wherein the microporous activated carbon material is provided as a bag for receiving a bunch of grapes on the at least a portion of a grapevine, the bag has an opening through which the bunch of grapes is received, and an attachment means for closing the bag and securing the bag to the grapevine.

32. A protective covering according to claim 29 wherein the microporous activated carbon material comprises a viscose material.

33. A protective covering according to claim 29 wherein the microporous activated carbon material comprises a cotton material.

34. A protective covering according to claim 29 wherein microporous activated carbon material is black in colour.

35. A protective covering according to claim 29 wherein the microporous activated carbon material is a cloth fabric.

36. A protective covering according to claim 29 wherein the microporous activated carbon material is a felt fabric.

37. A protective covering according to claim 29 wherein the microporous activated carbon material includes one or more heat-resistant materials.

38. A protective covering according to claim 29 wherein the microporous activated carbon material comprises two or more layers.

39. A protective covering according to claim 29 formed from two or more layers of material wherein at least one of the layers is the microporous activated carbon material.

40. A protective covering according to claim 29 wherein the microporous activate carbon material includes a reinforcing thread.

41. A protective covering according to claim 40 wherein the reinforcing thread is provided in the weft weave, the warp weave or both weaves.

42. A protective covering according to claim 40 wherein the reinforcing thread is introduced to the material prior to activation of the carbon.

43. A protective covering according to claim 29 wherein the specific surface area Brunauer Emmett Teller (BET) is at least 800+/−50 m²/g.

44. A protective cover according to claim 29 including at least one viewing window.

45. A protective cover according to claim 29 including at least one access flap.

46. A protective cover according to claim 29 including at least one elongate slot for access.

47. A protective cover according to claim 29 including at least one pocket.

48. A protective cover according to claim 29 including at least one light.

49. A protective cover according to claim 29 including at least one sensor.
